(19) United States
(12) Patent Application Publication
(10) Pub. No.: US 2008/0268914 A1
(43) Pub. Date: Oct. 30, 2008

(54) Wireless earphone with unidirectional and omnidirectional microphones

(76) Inventor: Lin-kar Gwee, Maryland points (SG)

Correspondence Address: SAM CHEN, 7F-1, 293, ROOSEVELT ROAD, SEC 3, TAIPEI, TW

(21) Appl. No.: 11/741,770

(22) Filed: Apr. 30, 2007

(51) Int. Cl. H04M 1/00

(52) U.S. Cl. 455/570; 455/569.1

(57) ABSTRACT

A wireless earphone (e.g., a Bluetooth earphone) is disclosed that includes a housing having a first hole and a second hole, a unidirectional microphone disposed rearward of the first hole; an omnidirectional microphone disposed rearward of the unidirectional microphone and under the second hole, and a mounting assembly in the housing for fastening the omnidirectional and unidirectional microphones. The earphone can substantially block out external noise and greatly reduce echo.

### BACKGROUND OF THE INVENTION

1. Field of Invention

The invention relates to wireless earphones and more particularly to such a wireless earphone having unidirectional and omnidirectional microphones with improved capability of blocking out external noise and greatly reducing echo.

2. Description of Related Art

A conventional wireless earphone is shown in FIG. 1 and comprises a housing A, a through hole B on the housing A, and a microphone C mounted at the blind end of the through hole B within the housing A.

Conventionally, microphones can be classified as unidirectional microphones and omnidirectional microphones depending on its capability of receiving sound waves from a single or any direction. The sound waves receiving capability of a unidirectional microphone cab be illustrated and described by a cardioid. A point of the cardioid facing the sound source has the highest sound sensitivity and an opposite point thereof has the lowest sound sensitivity. This has the advantage of blocking out a great amount of environmental noise.

Such conventional type of wireless earphone with microphone is used for mobile phone. It can receive signals through wireless communication channels such as by Bluetooth protocols and thus it is often called as Bluetooth earphone. However, noise isolation capability of the Bluetooth earphone with microphone is unacceptably low. Thus, the need for improvement still exists.

### SUMMARY OF THE INVENTION

It is therefore one object of the invention to provide a wireless earphone having unidirectional and omnidirectional microphones and spongy members so as to substantially block out external noise and greatly reduce echo.

The above and other objects, features and advantages of the invention will become apparent from the following detailed description taken with the accompanying drawings.

### BRIEF DESCRIPTION OF THE DRAWINGS

FIG. 1 is a sectional view of a portion of a conventional wireless earphone with microphone;

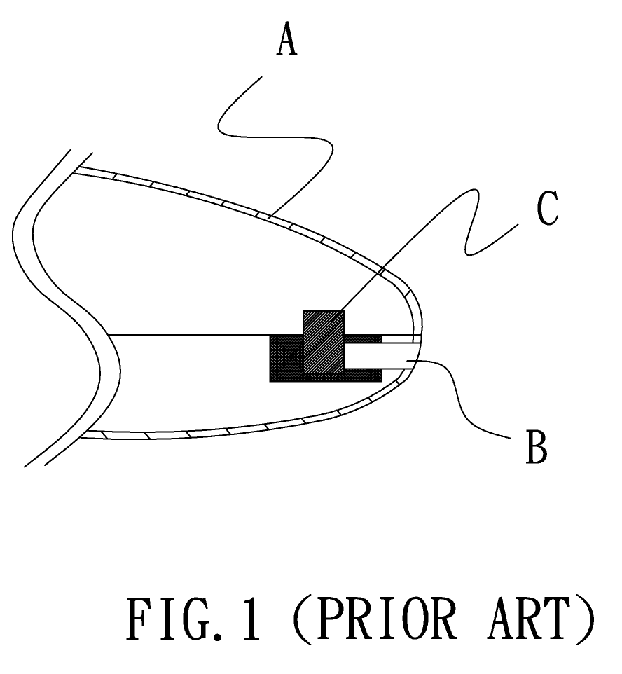

FIG. 2 is an exploded view of a preferred embodiment of wireless earphone according to the invention;

FIG. 3 is a view of the outer mounting member and the inner mounting member shown in FIG. 2 but viewed from an opposite angle;

FIG. 4 is an exploded perspective view of FIG. 2;

FIG. 5 is a sectional view of a portion of the assembled wireless earphone; and

FIG. 6 is a perspective view of the wireless earphone according to the invention.

### DETAILED DESCRIPTION OF THE INVENTION

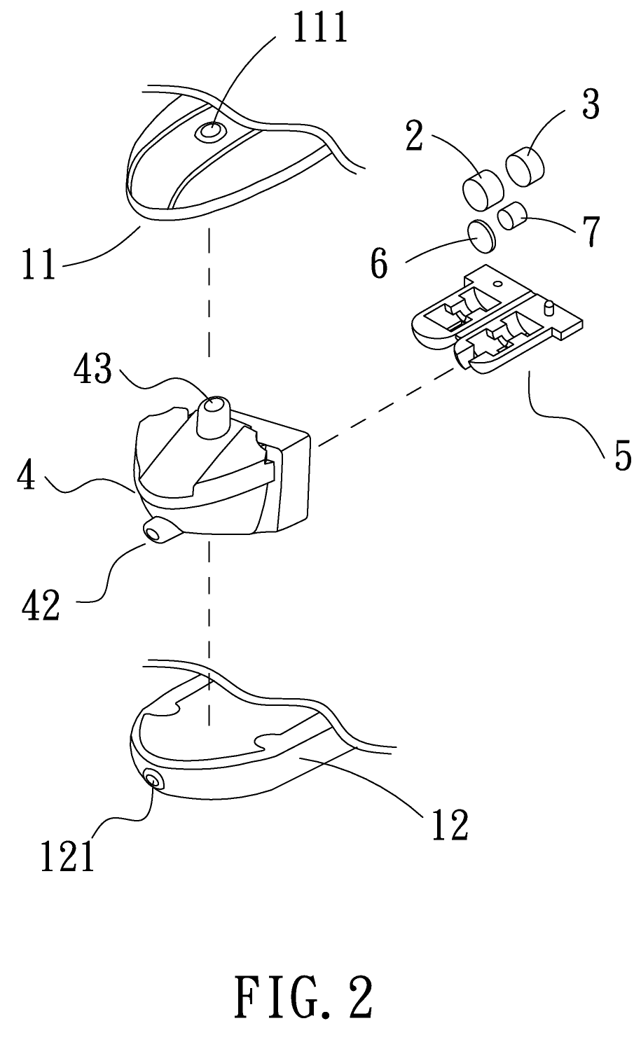

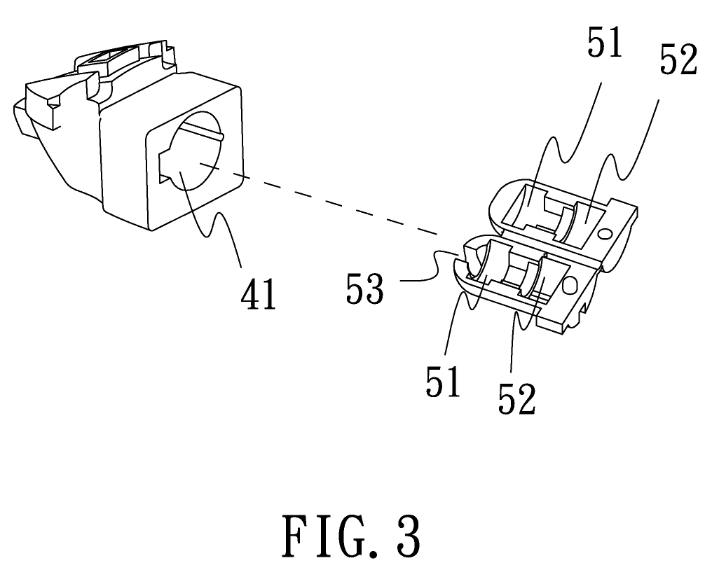

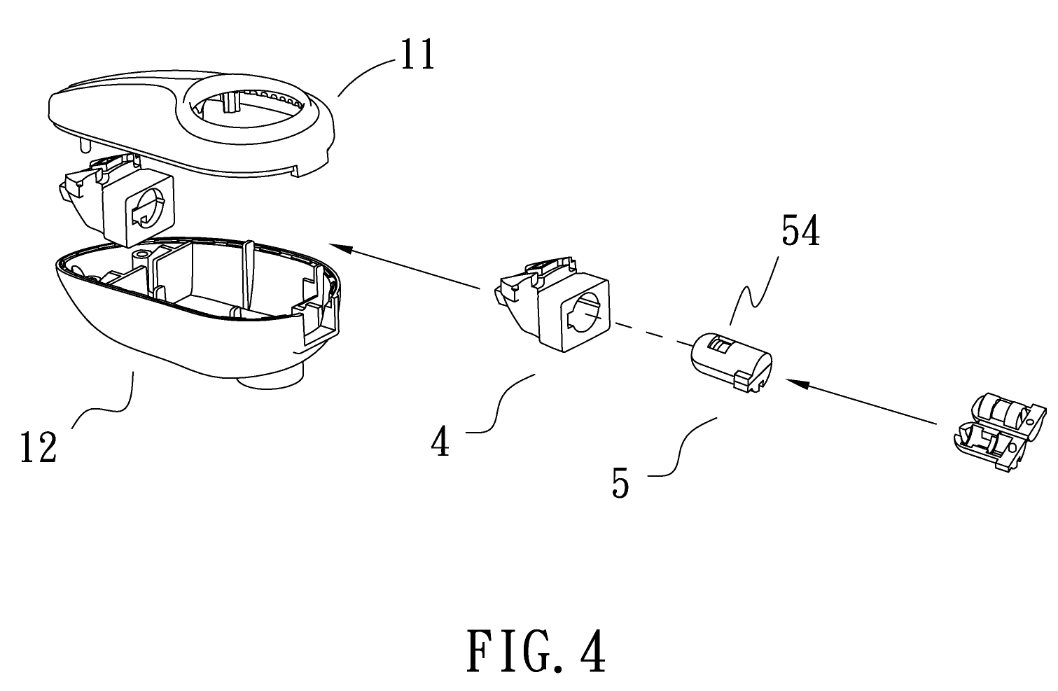

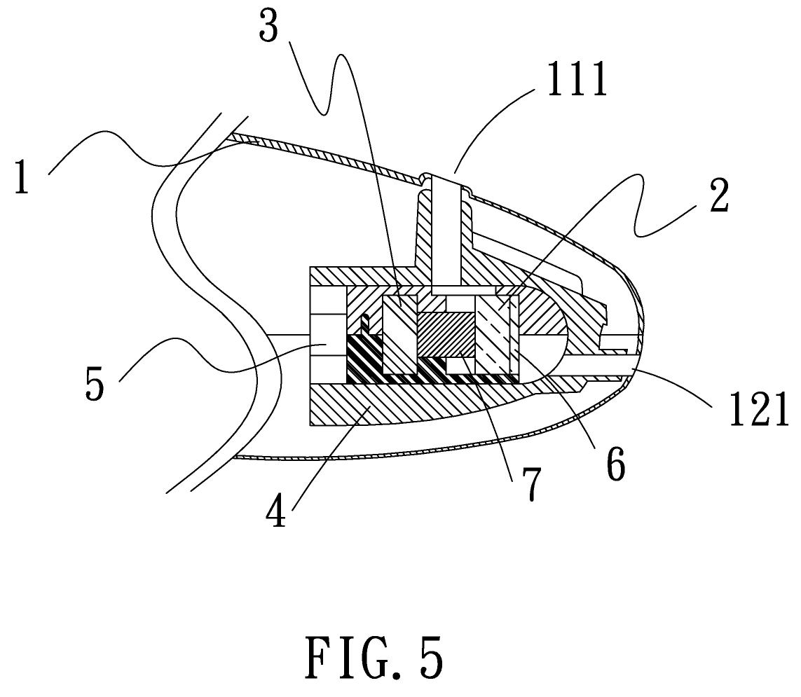

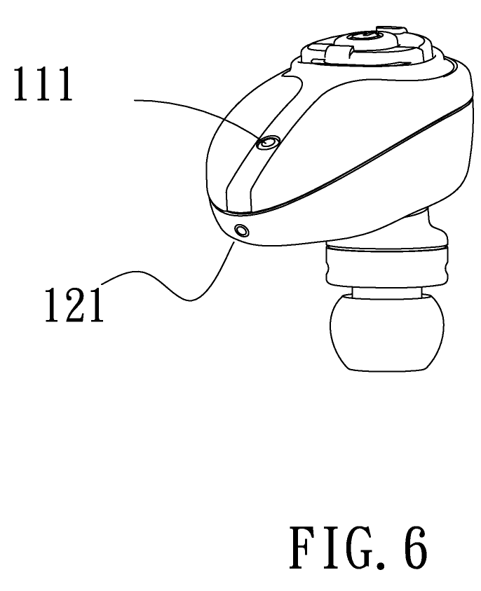

Referring to FIGS. 2 to 6, a wireless earphone in accordance with a preferred embodiment of the invention is shown. Preferably, the wireless earphone is implemented as a Bluetooth earphone. The wireless earphone comprises a housing 1 consisting of an upper shell 11 and a complimentary lower shell 12, a unidirectional microphone 2, an omnidirectional microphone 3, an outer mounting member 4, and an inner mounting member 5. Each component is discussed in detail below.

The concave lower shell 12 comprises a through hole 121 in the forward end. The concave upper shell 11 comprises a through hole 111 on the top. The outer mounting member 4 comprises a rear receptacle 41, a forward projecting channel 42, and a top projecting channel 43 in which the receptacle 41 communicates with both the channels 42 and 43. The inner mounting member 5 comprises a first half part and a connected, mated second half part. The concave first half part comprises a forward cylindrical well 51, a rear cylindrical well 52, and a top hole 54. The concave second part comprises a forward cylindrical well 51, a rear cylindrical well 52, and a forward opening 53 in communication with the forward cylindrical well 51 thereof.

The unidirectional microphone 2 is mounted in the assembled forward wells 51. The omnidirectional microphone 3 is mounted in the assembled rear wells 52. A cylindrical first spongy member 7 is mounted in a channel (not numbered) interconnecting the assembled forward and rear wells 51 and 52 and is engaged with the unidirectional microphone 2 and the omnidirectional microphone 3 at its both ends. A disc-shaped second spongy member 6 is mounted in a gap between the unidirectional microphone 2 and a forward wall of the assembled forward wells 51 and is engaged with the unidirectional microphone 2 and the forward wall at its both ends.

The assembled inner mounting member 5 is snugly fitted into the receptacle 41 for assembly. The opening 53 is aligned with the forward channel 42 and the hole 54 is aligned with the top channel 43 respectively in the assembled outer mounting member 4 and the inner mounting member 5. The assembled outer mounting member 4 and the inner mounting member 5 are mounted in the lower shell 12. Finally, the lower shell 12 is assembled with the upper shell 11 to form a complete housing 1.

In the assembled earphone the through hole 121 is aligned with the forward channel 42 and the through hole 111 is aligned with the top channel 43 respectively.

The unidirectional microphone 2 is capable of receiving sound waves from forward via the through hole 121, the forward channel 42, and the opening 53 only. Thus, a great amount of environmental noise is blocked out. Further, the through hole 111 is capable of greatly reducing echo. Furthermore, the omnidirectional microphone 3 is capable of making sound more pleasant to the ear.

Preferably, the inner mounting member 5 is made of elastomeric material and the outer mounting member 4 is made of silicone rubber. Preferably, the assembled outer and inner mounting members 4 and 5 occupy most internal space of the housing 1 for preventing components of the earphone from loosening. Moreover, the non-rigid outer and inner mounting members 4 and 5 can absorb shock and vibration of the earphone during operating.

While the invention herein disclosed has been described by means of specific embodiments, numerous modifications and variations could be made thereto by those skilled in the art without departing from the scope and spirit of the invention set forth in the claims.

What is claimed is:

1. A wireless earphone comprising:
a housing having a first hole and a second hole;
a unidirectional microphone disposed rearward of the first hole;
an omnidirectional microphone disposed rearward of the unidirectional microphone and under the second hole; and
a mounting assembly in the housing for fastening the omnidirectional and unidirectional microphones.

2. The wireless earphone of claim 1, wherein the mounting assembly comprises:
an outer mounting member including a projecting forward channel communicating with the first hole, a projecting top channel communicating with the second hole, and a rear receptacle communicating with the forward and top channels; and
a hollow inner mounting member mounted in the receptacle and including a forward opening communicating with the forward channel, and a top opening communicating with the top channel.

3. The wireless earphone of claim 2, wherein the inner mounting member is formed of an elastomeric material.

4. The wireless earphone of claim 2, wherein the outer mounting member is formed of silicone rubber.

5. The wireless earphone of claim 2, further comprising:
a first spongy member mounted in the inner mounting member and engaged with the unidirectional microphone and the omnidirectional microphone at both ends; and
a second spongy member mounted in the inner mounting member, spaced from the first spongy member, and engaged with the unidirectional microphone.
